(19) United States
(12) Patent Application Publication
(10) Pub. No.: US 2015/0088765 A1
(43) Pub. Date: Mar. 26, 2015

(54) SESSION MEMORY FOR VIRTUAL ASSISTANT DIALOG MANAGEMENT

(71) Applicant: ORACLE INTERNATIONAL CORPORATION, REDWOOD SHORES, CA (US)

(72) Inventors: DAVID FULTON, LIVINGSTON, MT (US); AMANDA SCHIFFRIN, AMSTELVEEN (NL); ALEXANDER VAN DER POL, ALMERE (NL)

(73) Assignee: ORACLE INTERNATIONAL CORPORATION, REDWOOD SHORES, CA (US)

(21) Appl. No.: 14/034,995

(22) Filed: Sep. 24, 2013

(51) Int. Cl. G06Q 30/00

(52) U.S. Cl. CPC G06Q 30/016
USPC 705/304

(57) ABSTRACT

Embodiments of the invention provide systems and methods for managing a customer interaction with a virtual assistant. Managing a customer interaction with a virtual assistant can comprise receiving a request to initiate an interaction between the virtual assistant and the customer. A context of the request or the interaction between the virtual assistant and the customer can be identified. The context can be based on information identifying at least one of the customer or a product or service that is a subject of the interaction. Information relevant to the interaction between the virtual assistant and the customer can be retrieved based on the identified context. The retrieved information can be stored in a session memory supporting the interaction and the interaction with the customer can be conducted dynamically through the virtual assistant based on the information stored in the session memory.

### BACKGROUND OF THE INVENTION

Embodiments of the present invention relate generally to methods and systems for managing a customer interaction with a virtual assistant and more particularly to using a session memory preloaded with specific information to dynamically provide a more focused set of information to a particular customer.

Increasingly, the preferred channels for customers seeking support, e.g., to find product information, obtain answers to questions about a product or service, request help on problems with products or services, etc., are various online channels. These channels can include, for example, a website or service that provides search features and/or other access to a knowledge base or other set of information. Historically, the focus of online service has been to answer as many questions as possible. Typically this is accomplished by building a generic knowledge base, provisioning it through the customer support website, and supporting search functions and/or question-and-answer sessions with a customer using the generic knowledge. For many customer questions, this is enough.

However, as the use of the online channel increases and interactions become more personal and less anonymous, questions that are more specific in nature are being asked and the generic knowledge base is becoming less sufficient. That is, these more specific questions are difficult to answer without more detailed knowledge of the customer and the customer's needs. For example, as a question becomes more specific to the products and/or services purchased by the individual, transactions of the individual, individual interests, preferences, etc., a more specific and more customized set of data needs to be available to adequately answer the question. Additionally, when a customer accesses the online channel on a mobile device, it is even more important to provide focused answers since the user is probably not willing to browse through generic content seeking a specific answer. Hence, there is a need for improved methods and systems for managing a customer interaction with a virtual assistant to provide a more focused set of information.

### BRIEF SUMMARY OF THE INVENTION

Embodiments of the invention provide systems and methods for managing a customer interaction with a virtual assistant. According to one embodiment, managing a customer interaction with a virtual assistant can comprise receiving a request to initiate an interaction between the virtual assistant and the customer. The request to initiate the interaction can comprise, for example, a request from the customer. A context of the request or the interaction between the virtual assistant and the customer can be identified. The context can be based on information identifying at least one of the customer or a product or service that is a subject of the interaction. Information relevant to the interaction between the virtual assistant and the customer can be retrieved based on the identified context. For example, the retrieved information can comprise one or more of customer information related to the customer participating in the exchange, product information related to the product or service that is the subject of the interaction, or knowledge base information. The retrieved information can be stored in a session memory supporting the interaction and the interaction with the customer can be conducted dynamically through the virtual assistant based on the information stored in the session memory.

Conducting the interaction can comprise selecting a dialog from a plurality of dialogs based on the information stored in the session memory. Each dialog can comprise a definition of a different process flow for conducting at least a portion the interaction between the customer and the virtual assistant based on and using the information stored in the session memory. The selected dialog can be executed, additional information can be received from the customer through the interaction of the customer with the virtual assistant based on the execution of the selected dialog, and the session memory can be updated with the received additional information.

A determination may be made as to whether the transaction between the customer and the virtual assistant is complete. In response to determining the interaction between the customer and the virtual assistant is not complete, a new dialog can be selected from the plurality of dialogs based on the updated information stored in the session memory, the selected new dialog can be executed, additional information can be received from the customer through the interaction of the customer with the virtual assistant based on the execution of the selected new dialog, and the session memory can be updated with the received additional information until a determination is made that the interaction is complete. In this way, the interaction can be dynamically guided based on execution of the dialogs selected based on current session memory information and using that current session state memory in the further interaction of the virtual assistant with the customer.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high-level, functional components of a system for virtual assistant dialog management according to one embodiment of the present invention.

FIG. 4 is a block diagram illustrating another view and additional details of updating session memory according to one embodiment of the present invention.

FIG. 5 is a flowchart illustrating a process for managing an interaction with a virtual assistant according to one embodiment of the present invention.

FIG. 6 is a flowchart illustrating a process for conducting an interaction based on a session memory according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the present invention relate generally to methods and systems for managing a customer interaction with a virtual assistant and more particularly to using a session memory preloaded with specific information to dynamically provide a more focused set of information to a particular customer. Using the information of the session memory, an interaction between the virtual assistant and a customer can be tailored to the individual customer. Furthermore, embodiments can manage this interaction by intelligently choosing what further information to solicit from the customer based on the information already available in the session memory. However, the information in the session memory need not all come from or be collected from the customer but some or all of it might be pushed from a Customer Relationship Management (CRM) system or elsewhere to the session memory before or upon the initiation of the interaction. That preloaded information can then be modified dynamically throughout the interaction. Using this set of dynamically maintained information in the session memory, the interaction between the virtual assistant and customer can be managed and tailored to specific questions of the individual customer.

It should be noted that while described herein with reference to a CRM system, various different implementations need not be limited to this type of application. Rather, embodiments described herein can be applied to any interaction where there is a possibility of a customer or user abandoning the exchange because the information provided is too generic and were a more tailored set of information and more dynamically adaptable flow for the interaction can help to answer more specific questions or meet more specific needs of individual customers or other users. Various additional details of embodiments of the present invention will be described below with reference to the figures.

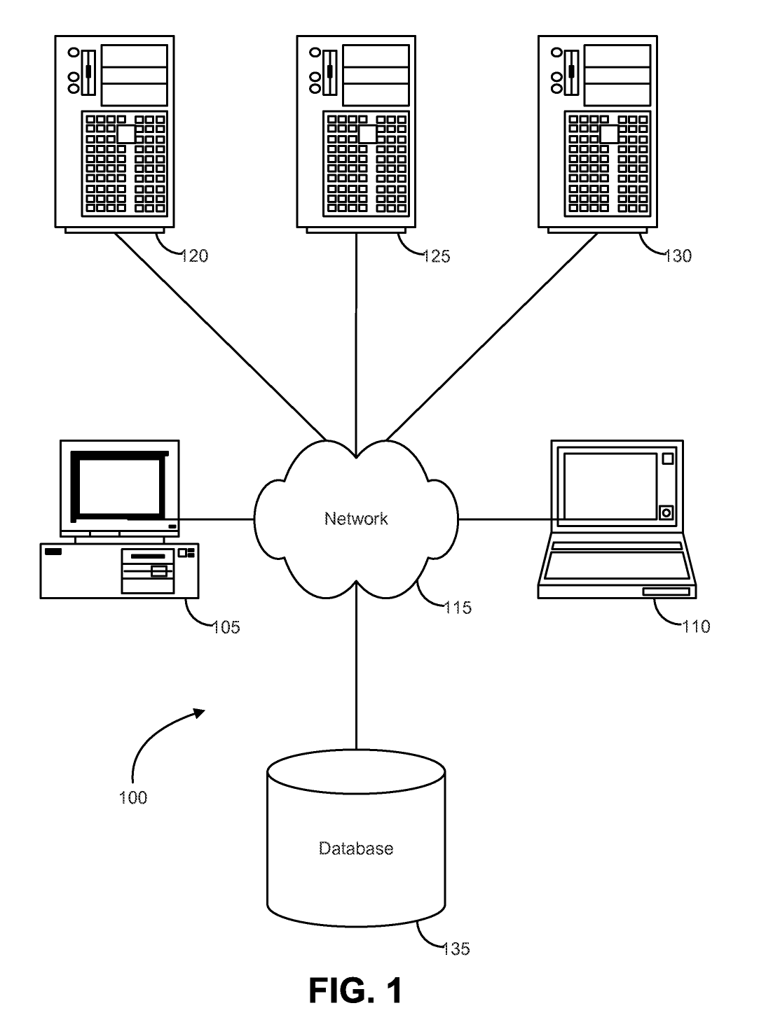

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

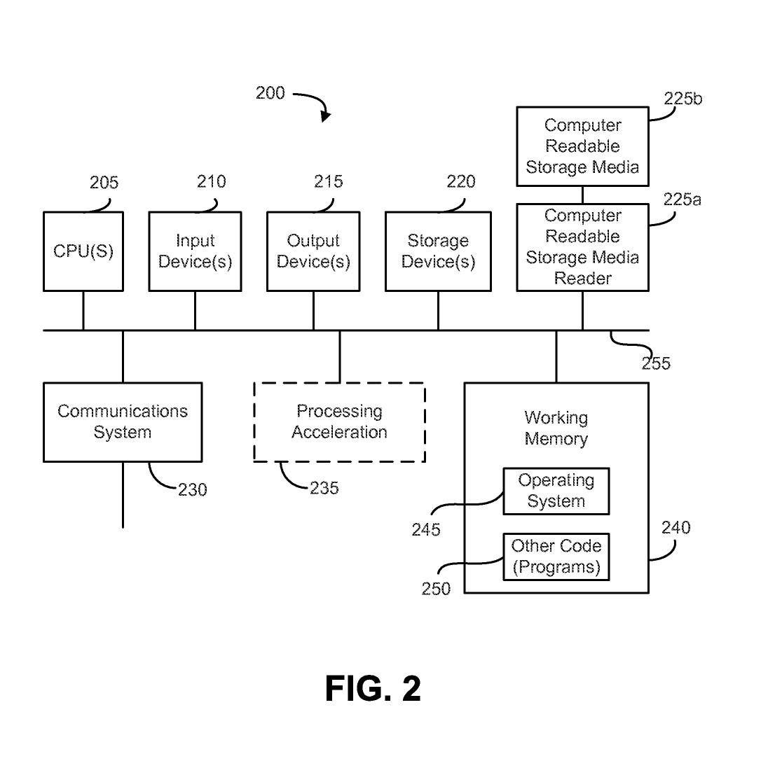

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

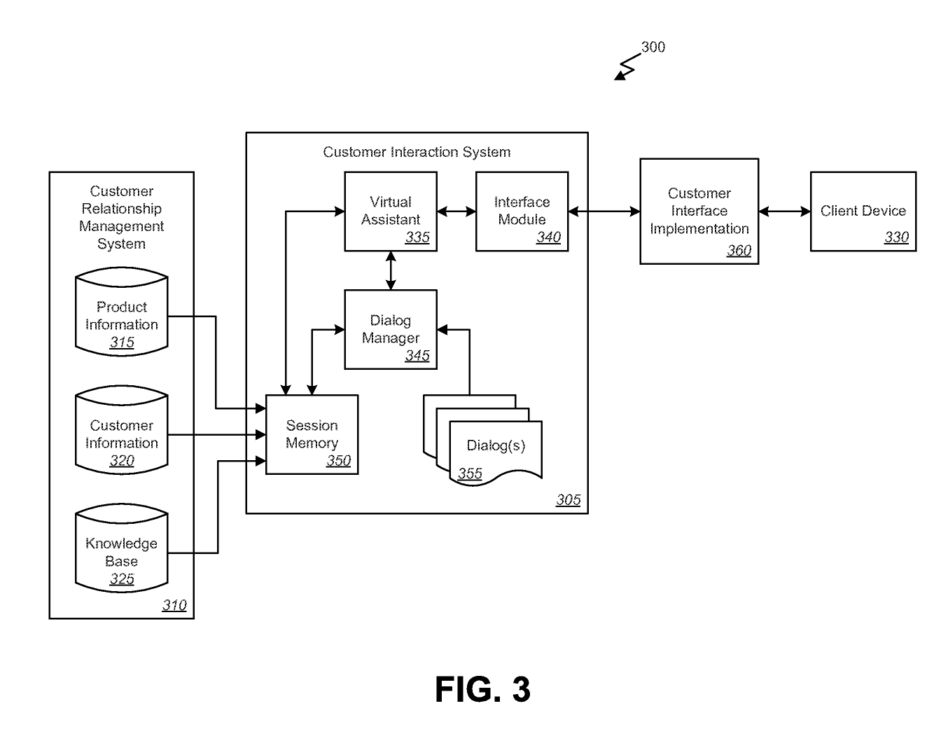

FIG. 3 is a block diagram illustrating, at a high-level, functional components of a system for virtual assistant dialog management according to one embodiment of the present invention. In this example, the system 300 includes a customer interaction system 305 and a Customer Relationship Management (CRM) system 310, each of which can be implemented by or on any one or more servers or other computer systems such as described above. It should be noted that, while illustrated here as separate, the CRM system 310 and customer interaction system 305 may, depending upon the exact implementation, be provided by the same system or set of systems. Generally speaking, CRM system 310 and customer interaction system 305 can operate in conjunction to provide support for customers of a product or service by allowing those users to make requests for service, report problems with those products or services, search for information, etc.

More specifically, the customer interaction system 305 provides for managing an interactions with a customer using a client device 330 such as a personal computer, tablet, cell phone, or any other computing device. For example, the customer interaction system 305 can include an interface module 340 for interfacing with a customer interface implementation 360, such as a web server, through which the client device 330 may access the customer interaction system 305 via a communication channel such as the Internet or other local or wide area network as described above. The customer interaction system 305 can also execute a virtual assistant 335. The virtual assistant 335 can comprise any of a variety of possible forms of automated assistant or guides for directing or aiding in an interactive communication with the customer through the interface module 340. For example, the virtual assistant 335 may comprise an animated avatar or other graphical representation presented to the client device 330 through a web page or other interface generated and provided by the interface module 340.

The customer interaction system 305 can also include a dialog manager 345. While illustrated here as separate components for the sake of simplicity, it should be noted that in some implementations, the virtual assistant 335, dialog manager 345, and possibly other elements (such as editors and/or administration modules not shown here) may be bundled together as part of a virtual assistant suite. Generally speaking, the dialog manager 345 can direct the virtual assistant 335 and help to manage an interaction between the virtual assistant 335 and the customer. Managing the interaction with the virtual assistant 335 can comprise receiving at the customer interaction system 305 a request to initiate an interaction between the virtual assistant and the customer. For example, the request to initiate the interaction can comprise a request from the client device 330 through the interface module 340. In other cases, the request can be received from a customer service agent using the CRM system, an automatically generated request based on the occurrence of a triggering event, etc.

Once the request has been received, a context of the request or the interaction to be conducted between the virtual assistant 335 and the customer can be identified by the dialog manager 345. The context can be based on information identifying the customer, information identifying a product or service that is to be a subject of the interaction, or on other information. For example, the context can be determined in whole or in part based on a cookie or other information received from the client device 330 and which can be used to identify the customer using the client device 330. Additionally or alternatively, such information may identify a product or service about which the customer is inquiring and which may be received with the request or in response to queries provided by the virtual assistant 335 and/or interface module 340.

Based on the identified context, additional information relevant to the interaction between the virtual assistant 335 and the customer can be retrieved from the CRM system 310 and stored in a session memory 350 of the customer interaction system 305 and supporting the interaction. For example, the retrieved information can comprise one or more of customer information 320 related to the customer participating in the exchange, product information 315 related to the product or service that is the subject of the interaction, and/or knowledge base 325 information from a CRM system 310, or other information. The interaction with the customer can then be conducted by the dialog manager 345 dynamically through the virtual assistant 335 based on the information stored in the session memory 350.

Conducting the interaction can comprise the dialog manager 345 selecting a dialog from a plurality of dialogs 355 based on the information stored in the session memory. Each dialog can comprise a script or other definition of a different process flow for conducting at least a portion the interaction between the customer and the virtual assistant 335 based on and using the information stored in the session memory. The selected dialog 355 can be executed by the dialog manager 345 to direct the virtual assistant 335. In some cases, the dialog manager 345 may also utilize a set of pre-defined questions (not shown here for the sake of simplicity) and/or other content as indicated by the dialogs 355. Under the direction of the dialog manager 345, additional information can be received from the customer through the interaction of the customer with the virtual assistant 345 based on the execution of the selected dialog 355. The session memory 350 can be updated with the received additional information. In some embodiments, there may be implemented two types of session memory. One type may be considered an in-dialog memory which can be transitory or non-persistent unless pushed to persistent session memory, and session memory which can be persistent for the duration of the session.

As the interaction progresses, a new dialog can be selected from the plurality of dialogs 355 based on the updated information stored in the session memory 350. That is, as the session memory 350 is updated through the course of the interaction, new dialogs may be selected based on the information provided. Selection of these dialogs 355 then controls the subsequent flow of the interaction and further information present to and/or collected from the customer. For example, the selected new dialog can be executed by the dialog manager 345, additional information can be received from the customer through the interaction of the customer with the virtual assistant 335 based on the execution of the selected new dialog, and the session memory 350 can be updated with the received additional information until a determination is made that the interaction is complete, e.g., based on indication from the customer that the question has been satisfactorily answered. In this way, the interaction can be dynamically guided by the dialog manager 345 based on execution of the dialogs 355 selected based on current session memory 350 information and using that current session memory in the further interaction of the virtual assistant 335 with the customer.

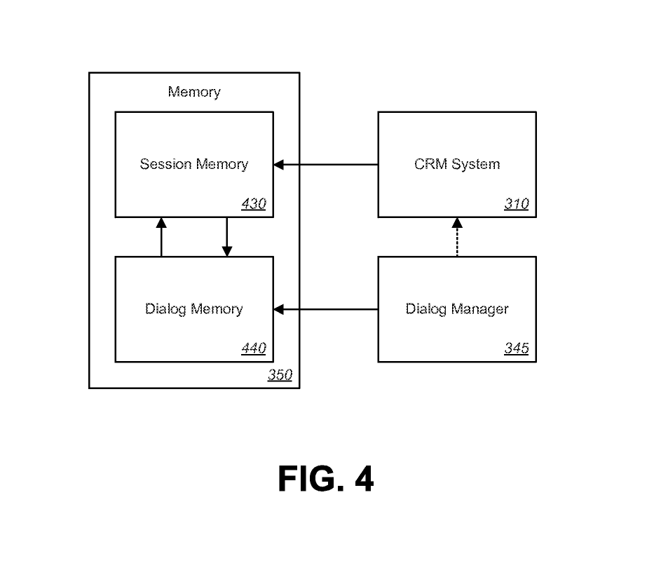

FIG. 4 is a block diagram illustrating another view and additional details of updating session memory according to one embodiment of the present invention. As illustrated in this example, CRM system 310 can push items in session memory 430 at any point, but usually at the start of the session. Session memory 430 can updates items in dialog memory 440 depending upon the context of the request and the links between session memory 430 and dialog memory 440 defined in the dialog manager 345. Dialog memory 440 can update, create or remove items in session memory 430 depending upon the context of the request and the links between dialog memory 440 and session memory 430 defined in the dialog manager 410. Dialog manager 345 can push items into dialog memory 440 depending upon the context of the request. The CRM system 310 could accept updates from the session memory 430 through the dialog manager 345 based on triggers in the dialog.

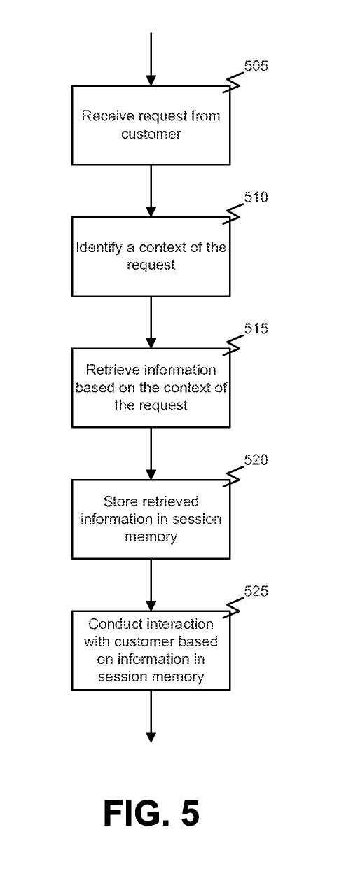

FIG. 5 is a flowchart illustrating a process for managing an interaction with a virtual assistant according to one embodiment of the present invention. In this example, processing begins with receiving 505 a request to initiate an interaction between the virtual assistant and the customer. The request to initiate the interaction can comprise, for example, a request from the customer, from a customer service agent, an automatically generated request based on the occurrence of a triggering event, etc.

Once the request has been received 505, a context of the request or the interaction to be conducted between the virtual assistant and the customer can be identified 510. Additionally or alternatively, the dialog to be entered can also be identified 510. There are then a number of dialog steps (which can themselves also be dialogs) which the virtual assistant can step through dynamically, dependent on the information the user has provided 505, and the current information residing in the session memory. The context can be based on information identifying the customer, information identifying a product or service that is to be a subject of the interaction, or on other information. The context can additionally or alternatively be based on what is already present in session memory. In some embodiments, there may be implemented two types of session memory. One type may be considered an in-dialog memory which can be transitory or non-persistent unless pushed to persistent session memory, and session memory which can be persistent for the duration of the session.

Based on the identified context, information relevant to the interaction between the virtual assistant and the customer can be retrieved 515 and stored 520 in a session memory supporting the interaction. For example, the retrieved information can comprise one or more items of customer information related to the customer participating in the exchange, product information related to the product or service that is the subject of the interaction, knowledge base information from a CRM system, or other information. The interaction with the customer can then be conducted 525 dynamically through the virtual assistant based on the information stored in the session memory.

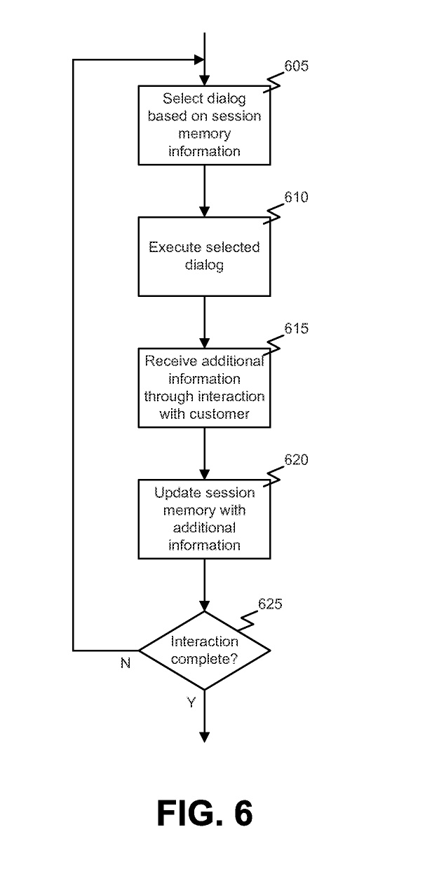

FIG. 6 is a flowchart illustrating a process for conducting an interaction based on a session memory according to one embodiment of the present invention. In this example, conducting 525 the interaction can comprise selecting 605 a dialog step from a plurality of dialog steps based on the information stored in the session memory. Each dialog step can comprise a definition of a different process flow for conducting at least a portion of the interaction between the customer and the virtual assistant based on and using the information stored in the session memory. The selected dialog can be executed 610 and additional information can be received 615 from the customer through the interaction of the customer with the virtual assistant based on the execution 610 of the selected dialog. The session memory can be updated 620 with the received additional information. It should be noted that session memory need not be limit to use in a binary fashion to select hardcoded dialogs and the dialogs do not need to be managed directly as part of the session memory object. Rather, the session memory might be used, in some cases, to highlight what happens with one or more communication channels. For example, a chat invite might be explicitly referenced as a reached ‘state’ in order to not offer chat interactions multiple times.

A determination 625 can be made as to whether the transaction between the customer and the virtual assistant is complete. In response to determining 625 the interaction between the customer and the virtual assistant is not complete, a new dialog can be selected 605 from the plurality of dialogs based on the updated information stored in the session memory, the selected new dialog can be executed 610, additional information can be received 615 from the customer through the interaction of the customer with the virtual assistant based on the execution 610 of the selected new dialog, and the session memory can be updated 620 with the received additional information until a determination 625 is made that the interaction is complete. In this way, the interaction can be dynamically guided based on execution of the dialogs selected based on current session memory information and using that current session state memory in the further interaction of the virtual assistant with the customer.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for managing a customer interaction with a virtual assistant, the method comprising:
receiving a request to initiate an interaction between the virtual assistant and the customer;
identifying a context of the request or the interaction between the virtual assistant and the customer;
retrieving information relevant to the interaction between the virtual assistant and the customer based on the identified context;
storing the retrieved information in a session memory supporting the interaction; and
conducting the interaction with the customer dynamically through the virtual assistant based on the information stored in the session memory.

2. The method of claim 1, wherein the request to initiate the interaction comprises a request from the customer.

3. The method of claim 1, wherein the context is based on information identifying at least one of the customer or a product or service that is a subject of the interaction.

4. The method of claim 3, wherein the retrieved information comprises one or more of customer information related to the customer participating in the exchange, product information related to the product or service that is the subject of the interaction, or knowledge base information.

5. The method of claim 1, wherein conducting the interaction comprises:
selecting a dialog from a plurality of dialogs based on the information stored in the session memory;
executing the selected dialog;
receiving additional information from the customer through the interaction of the customer with the virtual assistant based on the execution of the selected dialog; and
updating the session memory with the received additional information.

6. The method of claim 5, wherein each dialog comprises a definition of a different process flow for conducting at least a portion the interaction between the customer and the virtual assistant based on and using the information stored in the session memory.

7. The method of claim 6, further comprising determining whether the transaction between the customer and the virtual assistant is complete.

8. The method of claim 7, further comprising, in response to determining the interaction between the customer and the virtual assistant is not complete:
selecting a new dialog from the plurality of dialogs based on the updated information stored in the session memory;
executing the selected new dialog;
receiving additional information from the customer through the interaction of the customer with the virtual assistant based on the execution of the selected new dialog; and
updating the session memory with the received additional information.

9. A system comprising:
a processor; and
a memory coupled with and readable by the processor and storing therein a set of instructions which, when executed by the processor, causes the processor to manage a customer interaction with a virtual assistant by:
receiving a request to initiate an interaction between the virtual assistant and the customer;
identifying a context of the request or the interaction between the virtual assistant and the customer;
retrieving information relevant to the interaction between the virtual assistant and the customer based on the identified context;
storing the retrieved information in a session memory supporting the interaction; and
conducting the interaction with the customer dynamically through the virtual assistant based on the information stored in the session memory.

10. The system of claim 9, wherein the request to initiate the interaction comprises a request from the customer.

11. The system of claim 9, wherein the context is based on information identifying at least one of the customer or a product or service that is a subject of the interaction.

12. The system of claim 11, wherein the retrieved information comprises one or more of customer information related to the customer participating in the exchange, product information related to the product or service that is the subject of the interaction, or knowledge base information.

13. The system of claim 9, wherein conducting the interaction comprises:
selecting a dialog from a plurality of dialogs based on the information stored in the session memory;
executing the selected dialog;
receiving additional information from the customer through the interaction of the customer with the virtual assistant based on the execution of the selected dialog; and
updating the session memory with the received additional information.

14. The system of claim 13, wherein each dialog comprises a definition of a different process flow for conducting at least a portion the interaction between the customer and the virtual assistant based on and using the information stored in the session memory.

15. The system of claim 14, further comprising determining whether the transaction between the customer and the virtual assistant is complete.

16. The system of claim 15, further comprising, in response to determining the interaction between the customer and the virtual assistant is not complete:
selecting a new dialog from the plurality of dialogs based on the updated information stored in the session memory;
executing the selected new dialog;
receiving additional information from the customer through the interaction of the customer with the virtual assistant based on the execution of the selected new dialog; and
updating the session memory with the received additional information.

17. A computer-readable memory comprising a set of instructions stored therein which, when executed by a processor, causes the processor to manage a customer interaction with a virtual assistant by:
receiving a request to initiate an interaction between the virtual assistant and the customer;
identifying a context of the request or the interaction between the virtual assistant and the customer;
retrieving information relevant to the interaction between the virtual assistant and the customer based on the identified context;
storing the retrieved information in a session memory supporting the interaction; and
conducting the interaction with the customer dynamically through the virtual assistant based on the information stored in the session memory.

18. The computer-readable memory of claim 17, wherein conducting the interaction comprises:
selecting a dialog from a plurality of dialogs based on the information stored in the session memory, wherein each dialog comprises a definition of a different process flow for conducting at least a portion the interaction between the customer and the virtual assistant based on and using the information stored in the session memory;
executing the selected dialog;
receiving additional information from the customer through the interaction of the customer with the virtual assistant based on the execution of the selected dialog; and
updating the session memory with the received additional information.

19. The computer-readable memory of claim 18, further comprising determining whether the transaction between the customer and the virtual assistant is complete.

20. The computer-readable memory of claim 19, further comprising, in response to determining the interaction between the customer and the virtual assistant is not complete:
selecting a new dialog from the plurality of dialogs based on the updated information stored in the session memory;
executing the selected new dialog;
receiving additional information from the customer through the interaction of the customer with the virtual assistant based on the execution of the selected new dialog; and
updating the session memory with the received additional information.
